(19) United States
(12) Patent Application Publication
(10) Pub. No.: US 2007/0211226 A1
(43) Pub. Date: Sep. 13, 2007

(54) Light leakage preventive structure for front projector

(76) Inventor: Heng Chun Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,979

(22) Filed: Mar. 9, 2006

(51) Int. Cl. G03B 21/14

(52) U.S. Cl. 353/97

(57) ABSTRACT

A light leakage preventive structure for front projector includes an octagonal mask fixedly disposed before a lens of the projector, so that a projected image sequentially passes the lens and the mask to effectively prevent light leakage around a screen showing the projected image.

### FIELD OF THE INVENTION

The present invention relates to a light leakage preventive structure for front projector, and more particularly to a light leakage preventive structure for front projector that effectively eliminates shadows around a projected image and thereby makes the projected image clearer.

### BACKGROUND OF THE INVENTION

Generally, when a front projector is used to project an image on a screen 17, shadows 18 would appear around the screen 17, as shown in FIG. 2. This condition is generally referred to as light leakage, which not only adversely affects the image quality on the screen 17, but also degrades the clarity of image being viewed. FIG. 1 shows a conventional projecting structure for solving the problem of light leakage. As shown, the projecting structure includes a light source 11. Light from the light source 11 passes a first optical lens 12 and a filter 13, and is then projected by a second optical lens 14 on an image chip 10 located before a lens 16. A mask 15 is disposed on the image chip 10 to prevent light leakage. An image is then magnified by the lens 16 to present on a screen 17.

It would increase the difficulty and complication of the manufacturing process, and accordingly, increase the cost of the above-described projecting structure when the mask 15 is disposed on the image chip 10.

Moreover, since the image on the image chip 10 has not been magnified and projected by the lens 16 of the projector, the mask 15 disposed on the image chip 10 must be highly precise in design.

Therefore, it is desirable to improve the conventional projecting structure.

### SUMMARY OF THE INVENTION

A primary object of the present invention is to provide a light leakage preventive structure for front projector, so that there is not any shadow around a screen when an image is projected on the screen by the projector.

Another object of the present invention is to provide a light leakage preventive structure for front projector, with which an image projected on a screen by the projector is clearer to upgrade the viewing quality.

A further object of the present invention is to provide a light leakage preventive structure for front projector, which can be manufactured at simplified process and largely reduced cost.

A still further object of the present invention is to provide a light leakage preventive structure for front projector, which includes a mask that does not require a high precision structure.

To achieve the above and other objects, the light leakage preventive structure for front projector according to the present invention includes a mask fixedly disposed after a lens of the projector, so that a projected image sequentially passes the lens and the mask to effectively eliminate shadows around a screen due to light leakage.

In the present invention, the mask is a polygonal mask, and is preferably an octagonal mask, so as to more effectively prevent light leakage at four corners of the image which has been refracted and projected by round lenses.

In the present invention, an openable protective door is provided on the projector in front of the mask, so that the protective door in the closed position acts to protect the lens of the projector.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the structure of a conventional projector;

FIG. 2 illustrates the light leakage when a conventional projector is used to show an image;

FIG. 3 shows the structure of a projector according to the present invention; and

FIG. 4 is an assembled perspective view of the projector of the present invention.

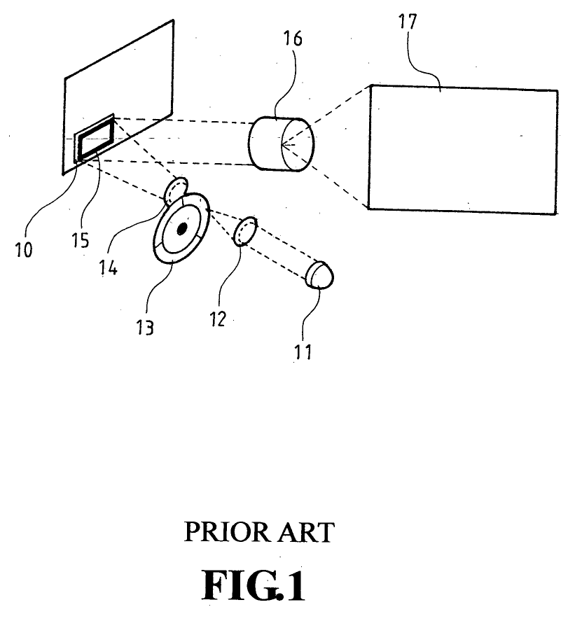

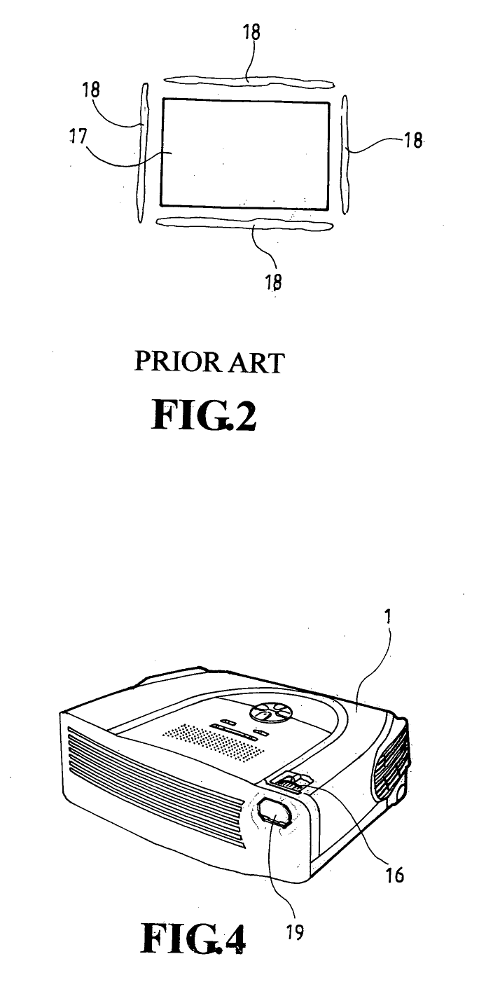

### DETAILED DESCRIPTION OF THE PREFERRED EMBODIMENTS

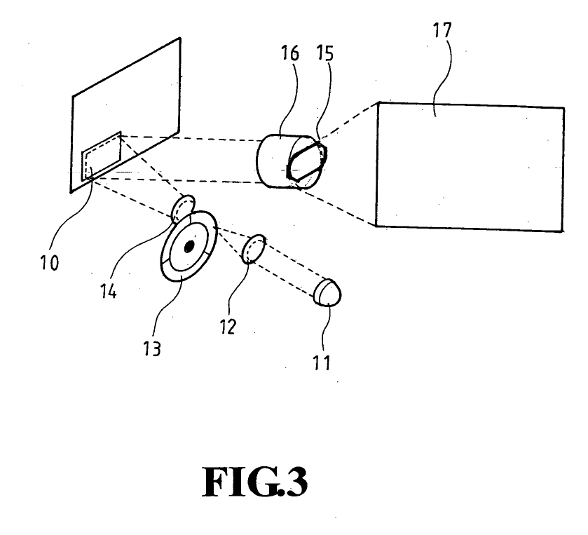

Please refer to FIG. 3. In a projector with the light leakage preventive structure of the present invention, a light source 11 is provided, so that light from the light source 11 passes a first optical lens 12 and is filtered by a light filter 13, and then passes a second optical lens 14 to project on an image chip 10. The light projected on the image chip 10 is then reflected from the image chip 10 to a lens 16 and is projected from the lens 16. A light leakage preventive mask 15 is fixedly disposed after the lens 16, so that an image is first magnified by the lens 16 and then passes the mask 15 to prevent light leakage before being projected to a screen 17. Since the mask 15 is disposed after the lens 16, any shadow due to light leakage after the magnification can be easily shielded. Therefore, when the magnified image is presented on the screen 17, any unwanted leaked light is effectively eliminated from peripheries of the screen 17, making the image clearer to upgrade the viewing quality.

To achieve the purpose of preventing light leakage, the mask 15 in the present invention is fixedly disposed after the lens 16, and is in a polygonal shape. In the illustrated embodiment of the present invention, the mask 15 is of octagonal. A polygonal mask 15 provides more effective shielding of leaked light, particularly the light leaked at four corners of the projected image. With the polygonal mask 15 fixedly disposed after the lens 16, an optical image having been refracted and projected by round lenses would present the optimum view angle.

Please refer to FIG. 4, which shows a projector 1 according to the present invention. As shown, an openable protective door 19 is provided in front of the lens 16 and the mask 15 of the projector 1, so that the door 19 in a closed position provides a protection to the lens 16.

With the mask 15 fixedly disposed after the lens 16, any light leakage is eliminated from the peripheries of the screen 17 when the projector 1 projects an image on the screen 17, and the purpose of preventing light leakage is effectively achieved.

What is claimed is:

1. A light leakage preventive structure for front projector, comprising a polygonal mask fixedly disposed after a lens of said projector, whereby an image projected by said projector is magnified by said lens and then passes said mask to eliminate any shadow around a screen on which the image is projected.

2. The light leakage preventive,structure for front projector as claimed in claim 1, further comprising an openable protective door mounted on said projector in front of said lens and said mask, so that said preventive door in a closed position provides a protection to said lens.
